(19) United States
(12) Patent Application Publication
(10) Pub. No.: US 2008/0128527 A1
(43) Pub. Date: Jun. 5, 2008

(54) LIQUID DISPENSING APPARATUS BASED ON PIEZOELECTRICALLY DRIVEN HOLLOW HORN

(75) Inventors: Helen Lai Wa Chan, Hong Kong (HK); Wencheng Xu, Hong Kong (HK); Kwok Ho Lam, Hong Kong (HK); Kin Wing Kwok, Hong Kong (HK)

Correspondence Address: EVAN LAW GROUP LLC, 600 WEST JACKSON BLVD., SUITE 625, CHICAGO, IL, 60661, US

(73) Assignee: THE HONG KONG POLYTECHNIC UNIVERSITY, Hong Kong (HK)

(21) Appl. No.: 11/567,208

(22) Filed: Dec. 5, 2006

(51) Int. Cl. B05B 17/04

(52) U.S. Cl. 239/4; 239/102.2

(57) ABSTRACT

A liquid dispensing apparatus, including a hollow horn having a central cylindrical cavity and a piezoelectric ring having a central opening. The piezoelectric ring is coupled to the hollow horn such that the central opening is in communication with one end of the central cylindrical cavity. A mesh screen is provided at the other end of the central cylindrical cavity. Liquid is delivered to an inner surface of the mesh screen through the central opening of the piezoelectric ring and the central cylindrical cavity of the hollow horn, and is dispensed from an outer surface of the mesh screen in the form of fine liquid droplets.

### FIELD OF THE INVENTION

The present invention relates generally to a liquid dispensing apparatus, and in particular to a liquid dispensing apparatus based on piezoelectrically driven hollow horn for dispensing liquid in the form of fine liquid droplets.

### BACKGROUND OF THE INVENTION

Liquid dispensers for producing fine liquid droplets or aerosols in industrial and medical applications are known. Nebulizer converts liquids into aerosol particles. It has been widely employed in industrial and medical applications; among which the ink-jet printing and drug delivering for respiratory tract devices have attracted considerable interest.

Some examples of industrial application on ink-jet printing were published in (i) S. Kameyama, H. Fukumoto, T. Kimura and S. Wadaka, Ink mist jet generation using low frequency focused ultrasonic waves and nozzle, Proc. of IEEE Ultra. Symp. 1 (1999) 695-678, (ii) G. Percin, and B. T. Khuri-Yakub, Piezoelectric droplet ejector for ink-jet printing of fluids and solid particles, Rev. Sci. Instrum, 74(2) (2003) 1120-1127, and (iii) G. Percin, and B. T. Khuri-Yakub, Micromachined droplet ejector arrays for controlled ink-jet printing and deposition, Rev. Sci. Instrum, 73(5) (2002) 2193-2196.

Some examples of medical application on drug delivering for respiratory tract devices were published, for example, in (i) D. Hess, Nebulizers: principles and performance. Respir Care, 45(6) (2000) 609-622, and (ii) R. Niven, Atomization and nebulizers. In: A. Hickey, editor, Inhalation aerosols: physical and biological basis for therapy, marcel Dekker, New York, 1996, 273-312.

There are various types of nebulizers. Pneumatic or jet nebulizers are the most traditional one which use compressed gas flow to disperse a liquid into a fine mist. Ultrasonic nebulizers are of another type, which uses a piezoelectric crystal to generate high frequency standing waves focused on the liquid surface. Fine liquid droplets separate from the crest of these waves to form an aerosol.

Recently, nebulizers of both the pneumatic and ultrasonic types, employing a fine mesh screen, have been developed. For the pneumatic type of mesh nebulizers, a gas stream is directed by a nozzle at the fine mesh screen over which is flowed the liquid to be fractured or divided into fine droplets, as disclosed in U.S. Pat. No. 4,941,618. The mesh of the screen is much finer than the gas stream resulting in the breaking up of the liquid as it is sheared away from or blown out of the screen mesh.

For the ultrasonic type of mesh nebulizers, the mesh screen is affixed to a vibration generator that is usually a piezoelectric ring of relatively large diameter, as disclosed in U.S. Pat. No. 5,938,117. When the vibration generator and hence the mesh screen oscillates, the apertures in the mesh screen draw fluid into their large openings and eject the fluid from their small openings. In this device, the vibrating surface is vibrating in a flexing mode, i.e. the vibration is not uniform across the surface, and only the central portion of the vibrating surface is provided with apertures for dispensing fine liquid droplets. There is a special cross-section profile for their vibrating surface, which is attached directly on the oscillator.

However, for most of these mesh nebulizers, it is necessary that a layer of fluid is to be formed and adhered in surface tension contact with the mesh screen. Hence, complicated and delicate design is necessary. For example, with this existing device, a relatively complicated design may be needed for enclosing the fluid around the vibrating element such that it is leakage-proof and does not affect the vibration of the vibrating surface. Therefore, a new different construction of mesh nebulizers is necessary to provide a smaller apparatus and simpler method to dispense liquids as fine droplets at a relatively low voltage.

The above description of the background is provided to aid in understanding the invention, but is not admitted to describe or constitute pertinent prior art to the invention, or consider the cited documents as material to the patentability of the claims of the present application.

### SUMMARY OF THE INVENTION

According to one aspect of the present invention, there is provided a liquid dispensing apparatus including a hollow horn having a central cylindrical cavity and a piezoelectric ring having a central opening. The piezoelectric ring is coupled to the hollow horn such that the central opening is in communication with one end of the central cylindrical cavity. A mesh screen is provided at the other end of the central cylindrical cavity. Liquid is delivered to an inner surface of the mesh screen through the central opening of the piezoelectric ring and the central cylindrical cavity of the hollow horn, and is dispensed from an outer surface of the mesh screen in the form of fine liquid droplets.

In this novel design, the mesh is vibrating in piston-like motion at a relatively high frequency (for example, a preferred frequency is 185 kHz). The vibration across the mesh is substantially uniform. The entire vibrating mesh is used for dispensing fine liquid droplets of small size. The mesh has a uniform thickness and simple geometry and thus easier to manufacture. The vibrating mesh is attached on a hollow step-horn, not directly on an oscillator. Because the liquid to be dispensed is not supported by the mesh itself, the resonance vibration of the mesh, including the frequency and amplitude, is not significantly affected by the liquid, which in this novel design is delivered to and contained in the cylindrical cavity before forming fine liquid droplets. The step horn works to amplify the vibration at the mesh and therefore does not rely on a more complex design of the mesh (e.g., a non-uniform cross-section profile and a flexing mode of vibration).

As the device of the present invention operates at a high frequency, the vibration amplitude required for dispensing fine liquid droplets is small. In addition, the output rate can be higher and/or the size of the device can be made smaller.

The device of the present invention does not require a layer of fluid adhered on the mesh screen. Rather, the liquid is easily and conveniently delivered to and contained in the cavity of the step horn, where it is in contact with the rare surface of the screen for dispensing fine liquid droplets. This design avoids the leakage problem and allows the device to operate in any orientation.

In one embodiment, the hollow horn has a base portion having a relatively larger outer diameter, and a tip portion having a relatively smaller outer diameter. The base portion has an outer diameter of about 12.7 mm and a length of about 6 mm, and the tip portion has an outer diameter of about 3.5 mm and a length of about 6 mm.

In one embodiment, the hollow horn is conical or exponential in shape.

In one embodiment, the hollow horn is made of titanium.

In one embodiment, the piezoelectric ring has an outer diameter of about 12.7 mm, an inner diameter of about 5 mm, and a thickness of about 1 mm. The piezoelectric ring has a planar electromechanical coupling coefficient of about 0.59. Of course, these particular parameters may be modified by people of ordinary skill in the art without undue experimentation. For example, the outer diameter may be between 10 mm to 20 mm, the inner diameter between 3 mm to 10 mm, and the thickness between 0.5 mm to 2 mm. Obviously, these parameters have to match the dimensions of the horn and the later needs to be optimized.

In one embodiment, the piezoelectric ring is made of piezoelectric ceramics. Other suitable materials may also be used.

In one embodiment, the mesh screen has a plurality of tapered holes, each having a relatively larger opening end at the inner surface of the mesh screen and a relatively smaller opening end at the outer surface of the mesh screen. The larger opening end has a diameter of about 40 μm and the smaller opening end has a diameter of about 4 μm. The mesh screen has about 12,000 holes/cm².

In one embodiment, the mesh screen is made of nickel. Other suitable materials may also be used.

According to another aspect of the present invention, there is provided a method of dispensing liquid in the form of fine liquid droplets comprising the steps of providing a hollow horn having a central cylindrical cavity; providing a piezoelectric ring having a central opening, the piezoelectric ring being coupled to the hollow horn such that the central opening is in communication with one end of the central cylindrical cavity; providing a mesh screen at the other end of the central cylindrical cavity; applying voltage of a predetermined frequency to the piezoelectric ring to drive the hollow horn and the mesh screen into vibration; and delivering liquid to an inner surface of the mesh screen through the central opening of the piezoelectric ring and the central cylindrical cavity of the hollow horn so that the liquid is dispensed from an outer surface of the mesh screen in the form of fine liquid droplets.

In one embodiment, the hollow horn and the mesh screen vibrate at an axial resonance frequency along the longitudinal direction of the hollow horn.

In one embodiment, the voltage is 30 V and the frequency is from 180 kHz to 190 kHz. Other voltages and frequencies may also be suitable.

Although the invention is shown and described with respect to certain embodiments, it is obvious that equivalents and modifications will occur to others skilled in the art upon the reading and understanding of the specification. The present invention includes all such equivalents and modifications, and is limited only by the scope of the claims.

### BRIEF DESCRIPTION OF THE DRAWINGS

Specific embodiments of the invention will now be described by way of example with reference to the accompanying drawings wherein:

FIG. 1 is a schematic illustration of a liquid dispensing apparatus according to an embodiment of the present invention;

FIG. 2 is a schematic cross-sectional view of the apparatus of FIG. 1;

FIG. 3 is an enlarged cross-sectional view of the mesh screen, showing the configuration of the tapered holes;

FIG. 4 shows the displacement of the tip of the hollow horn (under 3V driving voltage) in the axial direction as a function of frequency measured using a laser vibrometer;

FIG. 5 shows the displacement at the tip of the hollow horn at the axial resonance frequency as a function of the amplitude of the applied ac voltage; and

### DETAILED DESCRIPTION OF THE INVENTION

Reference will now be made in detail to an embodiment of the invention, examples of which are also provided in the following description. Exemplary embodiments of the invention are described in detail, although it will be apparent to those skilled in the relevant art that some features that are not particularly important to an understanding of the invention may not be shown for the sake of clarity.

Furthermore, it should be understood that the invention is not limited to the precise embodiments described below and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims.

In addition, improvements and modifications which may become apparent to persons of ordinary skill in the art after reading this disclosure, the drawings, and the appended claims are deemed within the spirit and scope of the present invention.

It should be noted that throughout the specification and claims herein, when one element is said to be “coupled” to another, this does not necessarily mean that one element is fastened, secured, or otherwise attached to another element. Instead, the term “coupled” means that one element is either connected directly or indirectly to another element or is in mechanical or electrical communication with another element.

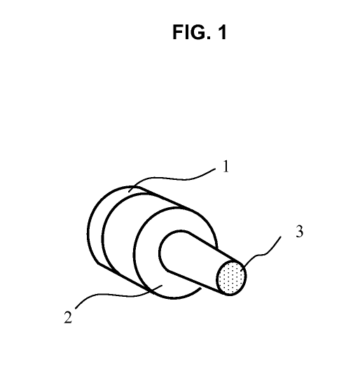

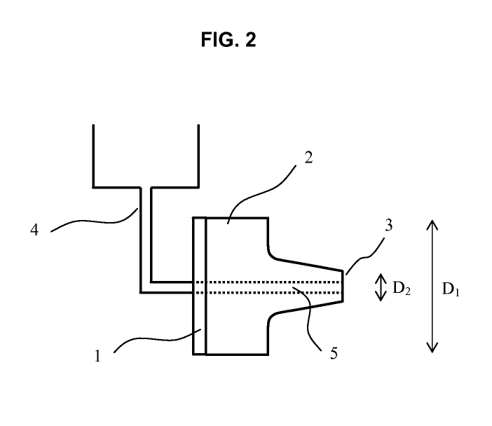

FIG. 1 shows schematically a liquid dispensing apparatus according to an embodiment of the present invention. The apparatus is used for dispensing liquids as a nebulizer. The apparatus has a piezoelectric ring 1, a hollow horn 2 and a mesh screen 3. FIG. 2 shows a schematic cross-sectional view of the apparatus, illustrating clearly the structure of the apparatus. Also shown in FIG. 2 is a simple liquid delivery system 4 in which a liquid is delivered to the rear surface of the mesh screen through the central hole of the piezoelectric ring 1 and the central cylindrical cavity 5 of the hollow horn 2 from a supply container, without in contact with other parts of the apparatus.

The piezoelectric ring 1 is the component to generate vibrations. It can be made of lead zirconate titanate piezoelectric ceramics or other piezoelectric ceramics. A piezoelectric material, such as the piezoelectric ceramic used in the present invention, is a material which can generate electric charges when it experiences a mechanical stress (direct piezoelectric effect) or produce a strain upon the application of an electric field (converse piezoelectric effect).

In the present invention, a piezoelectric ring is used, instead of a piezoelectric disk, to generate vibration so that the liquid can be directly and simply delivered to the rear surface of the mesh screen through the central hole of the piezoelectric ring 1 and the central cylindrical cavity 5 of the hollow horn 2 from a supply container, without in contact with other parts of the apparatus. The piezoelectric ring 1 of the present invention may, for example, have an outer diameter of about 12.7 mm, an inner diameter of about 5 mm, a thickness of about 1 mm, and a planar electromechanical coupling coefficient of about 0.59.

The hollow horn 2 is a mechanical transformer and the piezoelectric ring 1 is firmly attached to the top surface of the horn. It is the key component to amplify the vibration generated by the piezoelectric ring 1. It can be made of titanium or other metals and can be machined into any typical horn shapes, such as stepped (as shown in FIGS. 1 and 2), conical and exponential.

The magnification in the vibration occurred in the horn 2 is in general a function of the ratio of the base diameter to tip diameter of the horn. For a given ratio of diameters, the stepped horn has the largest vibration amplification and has been shown to be proportional to (D₁/D₂)² where D₁ is the base diameter and D₂ is the tip diameter (FIG. 2). A stepped horn with a central cylindrical cavity, i.e. a hollow stepped horn, is used in the present invention.

In order to reduce the high internal stress caused by the abrupt change in diameters of a standard stepped horn, two modifications have been made in the hollow stepped horn in the present invention. The first one is the addition of a radius fillet at the junction of the two sections of the stepped horn, and the second one is the change of the rod shape of the smaller section of the stepped horn to a cone shape. According to an embodiment of the present invention, the hollow stepped horn 2 has a base portion having an outer diameter of about 12.7 mm and a length of about 6 mm, and a smaller tip portion having an outer diameter of about 3.5 mm and a length of about 6 mm. The lengths of the base and the tip portions should be the substantially the same, so as to reduce the internal stress, in particular, at the step. The diameter of the cylindrical cavity 5 of the hollow horn 2 may be about 2 mm.

The mesh screen 3 is attached on the tip of the hollow horn 2 in such a way that the rear surface is in contact with the tip of the hollow horn 2 so that no liquid leaks from the edge of the screen. The mesh screen 3 contains numerous precision-formed tapered holes, having a larger opening at the rear or inner surface of the mesh screen and a smaller opening at the front or outer surface. The mesh screen 3 can be made of nickel or any other metals or metal alloys, and produced by electroplating.

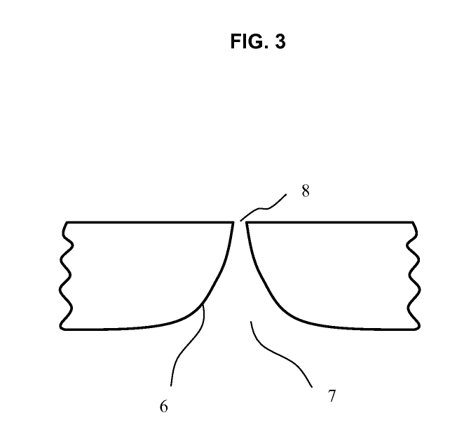

The tapered holes in the mesh screen 3 may be understood best by referring to FIG. 3. According to an embodiment of the present invention, the holes in the mesh screen 3 have a conical shape 6, with a large opening end 7 of a diameter of about 40 μm at the rear surface and a small opening end 8 of a diameter of about 4 μm at the front surface. There are approximately 12,000 holes/cm². As the mesh screen 3 is firmly attached on the tip of the hollow horn 2, it will vibrate following oscillations of the horn tip.

The liquid dispensing apparatus of the present invention is designed to be operated at the axial resonance frequency of the hollow horn 2. At the axial resonance frequency, the tip of the horn 2 oscillates uniformly and predominately along the length direction of the horn 2. By virtue of the contact with the tip, the perimeter of the mesh screen 3 is vibrated to oscillate along the length direction of the horn 2 at the same frequency. As the mesh screen 3 is not very large, the vibrating amplitudes at the perimeter and the center of the mesh screen 3 will not differ by too much, giving a rather uniform vibration across the mesh screen 3. This has been verified by experiments.

The vibrating mesh screen plays a very important role in dispensing a liquid as fine droplets. As the mesh screen 3 is vibrating at a high frequency, the liquid behind the mesh screen is pressed (relatively) into the holes and get accelerated. The liquid volume in the holes breaks off and form small droplets when the kinetic energy of the liquid is large enough to overcome the surface tension. Accordingly, a requirement of the velocity of the liquid volume in the hole V for forming droplets can be obtained, which is:

V>\sqrt{12σ/ρd} (1)

where σ is the coefficient of surface tension of the liquid, ρ is the density of the liquid, and d is the diameter of the ejected droplet which is close to the diameter of the small opening of the tapered holes. On the other hand, the maximum velocity of the liquid volume in the holes can be estimated by:

Vₘₐₓ=M·2πf·Z (2)

where f and Z are the vibrating frequency and vibrating amplitude of the mesh screen 3, and M stands for the acceleration result produced by the cone-shaped holes. Due to the incompressibility of the liquid, the flux at the entrance (i.e. the rear surface) and at the exit (i.e. at the front surface) of a hole should be the same; thus, the factor M could be approximately by:

M=V_{f}/Vᵣ=Aᵣ/A_{f}=(dᵣ/d_{f})² (3)

where V is the velocity of the flux, A is the area and d is the diameter of the hole, the subscripts f and r stand for the front and rear surfaces, respectively. In combining the above equations 1 and 2, the requirement of the vibration of a mesh screen for dispensing a liquid as fine droplets through the mesh screen is given as:

$$Zf > \frac{1}{π M} \sqrt{\frac{3 σ}{ρ {d}_{f}}} \qquad ( 4 )$$

Referring to equation 4, it can be seen that both a high vibrating frequency and a large vibrating amplitude are favorable for dispensing a liquid as fine droplets through a mesh screen.

In an example of the present invention, the mesh screen 3 with tapered holes having a large opening end of diameter 40 μm and a small opening end of diameter 4 μm is used. So, the maximum value of the factor M is approximately 100. However, there are other factors, such as viscosity which tends to lower the value of M, so a value of 10 (or a value in the order of 10) can be assumed for the factor M. With the values of σ and ρ of the liquid, the minimum value of the product of Z (the vibrating amplitude) and f (the vibrating frequency) for the mesh screen for dispensing liquid as fine droplets can be calculated. For the case of dispensing water at room temperature using the present invention, σ equals 72.7×10⁻³ N/m, p equals 1000 kg/m³; then the minimum value of the product Zf is about 0.235 m/s.

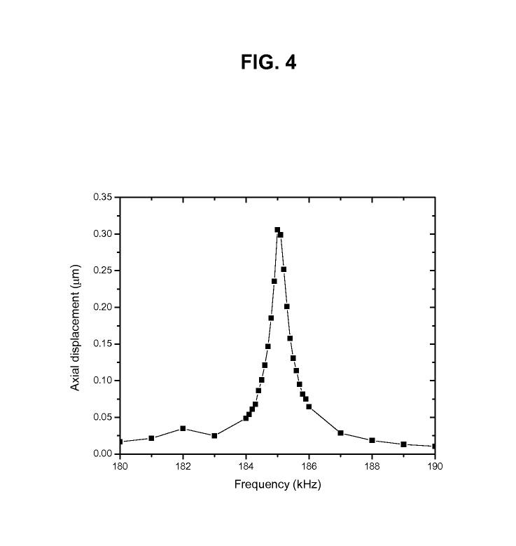

FIG. 4 shows the displacement of the tip of the hollow horn 2 in the axial direction as a function of frequency measured using a laser vibrometer (Polytec OFV 3000). An ac voltage of amplitude 3 V and frequency ranging from 180 kHz to 190 kHz is applied to the piezoelectric ring 1 to set the apparatus into vibration. The laser beam from the laser vibrometer is focused at the tip of the hollow horn 2. Similar results have been observed for the cases with the laser beam focused at different positions of the tip of the horn 2 as well as different positions of the mesh screen. The observed displacement is shown in FIG. 4 as a function of frequency. It can be seen that the observed displacement reaches a maximum value of approximately 0.30 μm at 185.0 kHz. This displacement peak corresponds to the fundamental axial resonance mode of the hollow horn and has been confirmed by the simulated animation using a finite element modeling.

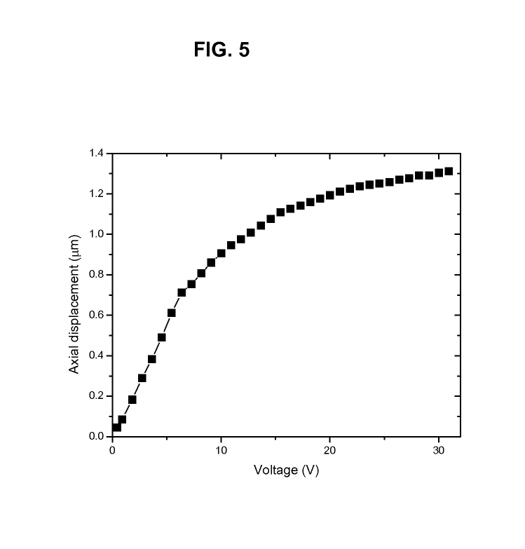

FIG. 5 shows the displacement of the tip of the hollow horn 2 at the axial resonance frequency (i.e. 185.0 kHz) as a function of the amplitude of the applied ac voltage. It is seen that the displacement increases with increasing ac voltage. At an ac voltage of amplitude 30 V, the displacement is about 1.3 μm, giving a value of 0.246 m/s for the product of Zf. Similar displacement values have also been observed at different positions of the mesh, including the perimeter and the center. That means, the value of the product of Zf is about 0.246 m/s everywhere across the mesh screen 3, and hence, according to equation 4, the mesh screen 3 can dispense water as fine droplets across the whole mesh screen at a relatively low voltage of 30 V. This has been proved by the experiment in which fine water droplets was successfully generated by the liquid dispensing apparatus of the present invention operated at 30 V and 185 kHz.

The liquid dispensing apparatus of the present invention is relative simple as compared to the prior art. No complicated and delicate design/arrangement is needed to form a layer of liquid on the mesh screen to generate fine liquid droplets. The liquid is directly delivered to the rear surface of the mesh screen through the central cylindrical cavity of the horn from a supply container. Furthermore, according to the present invention, there is no special design to prevent the liquid from contacting other parts (e.g. the piezoelectric ring) of the apparatus.

The liquid dispensing apparatus of the present invention can be operated at a relatively high frequency, e.g. 185 kHz, such that a high output rate can be achieved. On the other hand, for the same output rate, a mesh screen of smaller area can be used and hence the size of a portable liquid dispensing apparatus according to the present invention can be further decreased.

The liquid dispensing apparatus of the present invention provides a large vibration of the mesh screen to dispense the liquid through the holes of the mesh screen. The hollow horn is a mechanical transformer to amplify the axial vibration generated by the piezoelectric ring which offers better efficiency in converting electrical energy to mechanical energy as compared with a piezoelectric disk. Furthermore, by operating the apparatus at the axial mode resonance frequency of the hollow horn, the vibration at the tip of the hollow horn can be further increased, for example, reaching a large value of about 1 μm at a driving voltage of 12 V. The resonance or operating frequency of the apparatus can be adjusted by using different lengths of the hollow horn to meet different application requirements.

The present invention provides a more uniform vibration across the mesh screen to dispense the liquid through the holes of the mesh screen. As compared to the mesh screen of nebulizers operated based on the flexing resonance mode, the mesh screen of the present invention has a piston-like vibration at the tip of the hollow horn which makes the whole mesh screen more effective in dispensing fine liquid droplets.

While the present invention has been shown and described with particular references to a number of preferred embodiments thereof, it should be noted that various other changes or modifications may be made without departing from the scope of the present invention.

What is claimed is:

1. A liquid dispensing apparatus comprising:
(a) a hollow horn having a central cavity;
(b) a vibration generator having a central opening, said vibration generator being coupled to said hollow horn such that said central opening is in communication with one end of said central cavity of said hollow horn;
(c) a mesh screen covering another end of said central cavity of said hollow horn, having an inner surface facing towards said central cavity and an outer surface; and
(d) a liquid connector for delivering liquid to said inner surface of said mesh screen from a liquid storage.

2. The liquid dispensing apparatus of claim 1, wherein said hollow horn has at said one end of said central cavity a base portion having a relatively larger outer diameter, and at said another end of said central cavity a tip portion having a relatively smaller outer diameter, said vibration generator is a piezoelectric ring, and said central cavity is a cylindrical cavity.

3. The liquid dispensing apparatus of claim 2, wherein said base portion has an outer diameter of about 12.7 mm and a length of about 6 mm, and said tip portion has an outer diameter of about 3.5 mm and a length of about 6 mm.

4. The liquid dispensing apparatus of claim 1, wherein said hollow horn is conical or exponential in shape.

5. The liquid dispensing apparatus of claim 1, wherein said hollow horn is made of titanium.

6. The liquid dispensing apparatus of claim 2, wherein said piezoelectric ring has an outer diameter of about 12.7 mm, an inner diameter of about 5 mm, and a thickness of about 1 mm.

7. The liquid dispensing apparatus of claim 2, wherein said piezoelectric ring has a planar electromechanical coupling coefficient of about 0.59.

8. The liquid dispensing apparatus of claim 2, wherein said piezoelectric ring is made of piezoelectric ceramics.

9. The liquid dispensing apparatus of claim 1, wherein said mesh screen comprises a plurality of tapered holes, each having a relatively larger opening end at said inner surface of said mesh screen and a relatively smaller opening end at said outer surface of said mesh screen.

10. The liquid dispensing apparatus of claim 9, wherein said larger opening end has a diameter of about 40 μm and said smaller opening end has a diameter of about 4 μm.

11. The liquid dispensing apparatus of claim 9, wherein said mesh screen has about 12,000 holes/cm².

12. The liquid dispensing apparatus of claim 1, wherein said mesh screen is made of nickel.

13. A method of dispensing liquid in the form of fine liquid droplets comprising the steps of:
(a) providing a hollow horn having a central cylindrical cavity;
(b) providing a piezoelectric ring having a central opening, said piezoelectric ring being coupled to said hollow horn such that said central opening is in communication with one end of said central cylindrical cavity;
(c) providing a mesh screen at the other end of said central cylindrical cavity;
(d) applying voltage of a predetermined frequency to said piezoelectric ring to drive said hollow horn and said mesh screen into vibration; and
(e) delivering liquid to an inner surface of said mesh screen through said central opening of said piezoelectric ring and said central cylindrical cavity of said hollow horn so that the liquid is dispensed from an outer surface of said mesh screen in the form of fine liquid droplets.

14. The method of claim 13 wherein said hollow horn and said mesh screen vibrate at an axial resonance frequency along the longitudinal direction of said hollow horn.

15. The method of claim 13 wherein said voltage is 30 V and said frequency is from 180 kHz to 190 kHz.

16. The method of claim 13 wherein said hollow horn has at said one end a base portion having a relatively larger outer diameter, and at said other end a tip portion having a relatively smaller outer diameter.

17. The method of claim 13 wherein said hollow horn is conical or exponential in shape.

18. The method of claim 13 wherein said mesh screen comprises a plurality of tapered holes, each having a relatively larger opening end at said inner surface of said mesh screen and a relatively smaller opening end at said outer surface of said mesh screen.

19. The method of claim 18 wherein said mesh screen has about 12,000 holes/cm².
